(19) United States
(12) Patent Application Publication
(10) Pub. No.: US 2004/0231957 A1
(43) Pub. Date: Nov. 25, 2004

(54) Transportation device

(76) Inventor: Alfred Multerer, Grabenstatt/Chiemsee (DE)

Correspondence Address: Stephen B. Salai, Esq., Harter, Secrest & Emery LLP, 1600 Bausch & Lomb Place, Rochester, NY, 14604-2711, US

(21) Appl. No.: 10/706,587

(22) Filed: Nov. 12, 2003

(30) Foreign Application Priority Data
May 21, 2003 (DE) 203 07 967. 1

(51) Int. Cl. B65G 17/00

(52) U.S. Cl. 198/321

(57) ABSTRACT

A device is disclosed for the transportation of objects and/or persons, in particular for use as a ski-lift, a T-bar lift or the like. Such devices generally comprise a driving station, a deflection or return station as well as a rope or wire rope circulating between the stations.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A “SEQUENCE LISTING”

Not applicable.

### BACKGROUND OF THE INVENTION

1 Field of the Invention

The present invention relates to a device for the transportation of objects and/or persons, in particular for use as a ski-lift, a T-bar lift or the like. Such devices generally comprise a driving station, a deflection or return station as well as a rope or wire rope circulating between said stations.

2 Description of Related Art

DE 696 07 479 T2 discloses a T-bar device with a rope for skiers, the rope runs in continuous use in a looped manner between the places for getting on and off, which are each equipped with two end coils, wherein the drag rope runs along or runs substantially parallel with the ski slope at a level such that it can be grasped by a person and the return run is supported by masts above the persons.

CH 390 978 describes a ski-lift with an endless transportation rope running over at least two drawback pulleys of which one is provided at the lower station and the other one at the upper station. The drawback pulleys rotate around an axis perpendicular to a base of a supporting frame of the station and are positioned on a level away from the base.

DE 30 33 601 Al discloses a ski-lift with an endless drag rope circulating under tension between a rope sheave at a driving station and a rope sheave at a return station. The rope sheaves are connected with a respective housing anchored to the ground at the driving and/or return station under rope tension in a way adjustable both in the height above the ground and around an axis parallel to the length of the rope, and, at least at the return station automatically, adjustable around an axis transverse to the length of the rope to a respective entering angle.

The systems known from the prior art can be divided in two groups. In the first group, the circulating transportation rope is in a plane substantially parallel to the transportation plane. The driving and deflection wheels are substantially horizontally orientated. Such arrangements turn out to be disadvantageous in that the skiers can only get on and off on one side, since this is not impossible on the other side due to the return run. Furthermore, the return run usually has to be secured by fencing.

In a second embodiment of a ski-lift according to the prior art, as described for example in DE 696 07 479 T2, the driving and deflection rollers are arranged perpendicular to the transportation plane so that the return run runs back above the transportation area of the rope or perpendicularly parallel thereto. Therefore, several small driving or deflection rollers are provided at the driving or return station of the ski-lifts. Deflection rollers are both provided at the height of the transportation level and at the height of the return run. This is disadvantageous since a great number of deflection pulleys and bearings are required, and the reliability is reduced due to the side-lining or side-tracking of the transportation rope using a pulley having a small diameter. Moreover, intermediate stations are generally necessary to support the rope along the transportation route.

### BRIEF SUMMARY OF THE INVENTION

An object of the present invention is to provide a device that fulfils the requirements described and overcomes the afore-mentioned disadvantages. It is a further object of the invention to provide a transportation device that provides safe, economical and/or effective operation as well as simple and safe handling.

A preferred form of the invention as a device for the transportation of objects and/or persons, includes at least one driving station and at least one deflection station as well as a transportation rope circulating between the stations. A single driving wheel is arranged at the driving station, and a single deflection pulley is arranged at the return station. The driving wheel and the deflection pulley are substantially perpendicular to each other.

Preferably, at least one of the deflection pulley and the driving wheel is suspended as a cantilever. The cantilever suspension is preferably adjustable. At least one of the driving wheel and the deflection pulley preferably has a diameter that is at least 60 times the diameter of the rope or at least 1 meter, or preferably 1.5 meters. A transportation device or a holding device can be arranged at the transportation rope.

### BRIEF DESCRIPTION OF THE SEVERAL VIEWS OF THE DRAWING(S)

The invention is described hereinafter with the preferred embodiments and the drawings:

FIG. 1 is a schematic drawing of a top view of a transportation device according to the invention; and

FIG. 2 is a side view of the device according to FIG. 1.

### DETAILED DESCRIPTION OF THE INVENTION

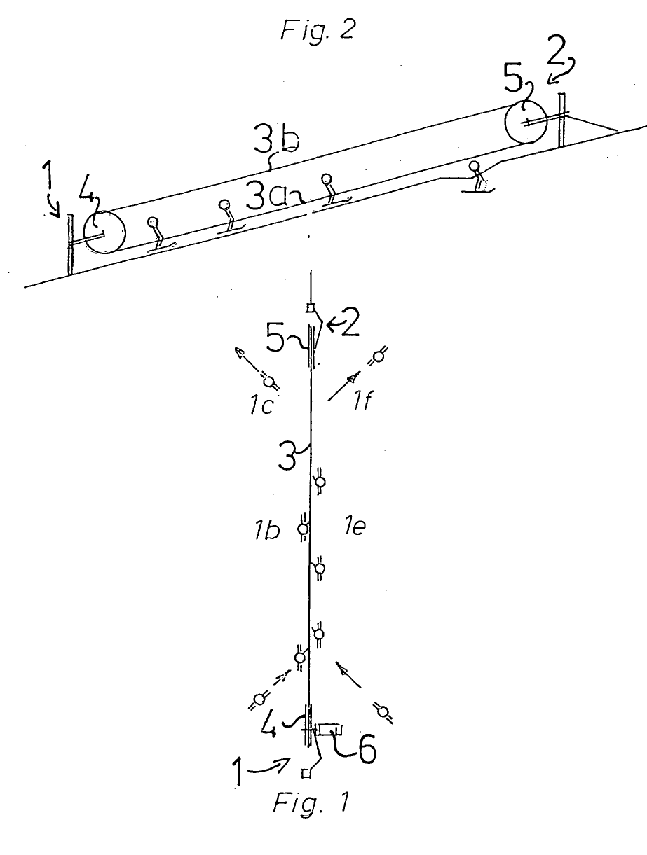

FIG. 1 shows a top view of a transportation device according to the invention with a driving station 1, a return or deflection station 2 as well as a transportation rope .3 circulating between the stations. The device further comprises a single driving wheel 4 provided at the driving station 1, and a single deflection pulley 5 provided at the return station. The driving wheel 4 and the deflection pulley 5 are arranged substantially vertically. The vertical arrangement of the driving and deflection pulleys also causes a vertical orientation of the plane in which the transportation 3a and return areas 3b (see FIG. 2) of the transportation rope 3 are parallely arranged. The size of the wheels and pulleys 4 and 5 preferably ensures safe operation of the transportation rope 3, in particular, by providing a relatively large contact surface or a relatively large angle of traction. Moreover or in addition, the diameter of the driving and drawback pulleys preferably ensure that the reversing area 3b of the transportation rope returns at a sufficient height above the skier.

As shown in FIG. 1 using arrows, the persons or skiers to be transported approach the transportation device, preferably at the same level as the valley station, grasp the transportation rope or a transportation means (not shown) attached thereto. The transportation device transports the person(s) to be conveyed from the driving station 1 in direction of the return/deflection station 2. Having arrived there, the skier or the person to be transported lets go of the rope or the transportation means. The vertical arrangement of the driving 4 or deflection wheels 5 enables the person to be transported to get on or off from both sides, as shown in FIG. 1. The skiers may approach the transportation device from both sides and get off the transportation device on both sides, for example, either to the right or left of the transportation direction without being obstructed or endangered by the returning rope.

This/These object/s is/are achieved with the features of the claims. The underlying idea of the invention is to provide a device for the transportation of objects and/or persons with at least one driving station and at least one return station as well as a transportation rope circulating between the stations, the device further comprising a single driving wheel arranged at the driving station, and a single drawback/deflection pulley arranged at the deflection or return station, in general arranged vertically. The driving wheel and the deflection pulley preferably have a diameter large enough for the return run to run back at a height sufficiently above the skier.

In a further preferred embodiment, a true adjustable cantilever suspension is used for the arrangement of the driving and deflection pulleys. Thus, rope torque, as is the case with any other arrangement, is prevented in advance without having to use additional run-in rollers.

The diameter of the driving wheel and/or drawback pulley is preferably at least about 60 times the diameter of the rope or at least about 600 times the diameter of the wire or at least about 1 m. Furthermore, the diameter preferably is at least about 1.20 m and most preferably at least about 1.50 m.

The driving wheel and/or deflection pulleys of the device according to the invention are preferably both adjustable in the height over the ground in parallel and adjustable by an axis running in parallel to the length of the rope and an axis running transversely to the length of the rope, the latter adjustment preferably being automatically. Thus, an adaptation of the transportation device to the respective ground conditions and/or operation conditions is possible.

The device according to the invention may be used as a ski-lift, in particular as a T-bar lift and as a lift for sledges, bob-sleighs, snow tubes, or the like. The device according to the invention cannot only be used in snow areas but also at summer toboggan runs and the like. Ropes, wires, strips and the like are particularly suitable as transportation ropes, wherein synthetic, natural fibers, chemical fibers, hemp, steel wires, galvanized wires and/or combination thereof are used preferably as materials.

Moreover, transportation and/or support means are provided preferably on the transportation rope. Preferably, supporting straps, fastening bows, fastening knobs and/or the like are used.

Preferably, a special, endlessly spliced, synthetic tow rope having preferably, vulcanized rubber burls is used as a transportation rope. The transportation rope preferably has a diameter of about 12 to 24 mm and most preferably of about 18 mm.

The suspension of the driving 4 and deflection 5 wheels is preferably carried out in a cantilevered manner and, in particular, preferably in an adjustable or adjustably cantilevered way. The driving wheels 4 and deflection pulleys 5 at the driving station 1 and/or the return station 2 are preferably adjustable under rope tension both in the height over the ground and around an axis running parallel to the length of the rope and around an axis running perpendicularly to the length of the rope, the latter adjustment preferably being automatically.

Furthermore, by using driving wheels 4 and deflection pulleys 5 having big diameters in a preferred embodiment, the implementing regulations according to the“Vorschriften für den Bau und Betrieb von Schleppaufzügen (BOSchlepp)”(regulations for the construction and operation of T-bar lifts), January 2002, are fulfilled, according to which (Section 12, regulation 12.5.1) the diameters of the driving pulley, the pulley for changing the direction of the rope and the deflecting sheave have to be at least 60 times the diameter of the rope and 600 times the diameter of the wire.

The transportation device according to the invention provides a T-bar lift, which enables safe operation of the ropes by the driving wheels and deflection pulleys and a safe arrangement of the returning rope. Namely, the returning rope is positioned sufficiently high enough over the skiers in order to minimize the danger of accidents and/or malfunctions. Moreover, by using a true cantilever suspension for at least one of the rope wheels, rope torque as known from the devices disclosed in the prior art is prevented in advance, without having to use additional run-in rollers. If the winding rope is brought off track due to one-sided loading, the deflection pulley automatically changes to the direction of the approaching rope so that there is no rope torque as is the case with rigid deflection pulleys.

By enabling the person to be transported to get on and off from both sides, the transportation efficacy of the transportation device is about twice as high as usual. Furthermore, by means of the vertical arrangement of the driving wheels and deflection pulleys, the slope can be better used as well as better prepared and maintained with slope maintenance devices.

The drive of the transportation device according to the invention is preferably carried out by a motor 6, which is positioned at the driving station 1 and drives the driving wheel 4. The motor 6 is preferably an electromotor, an Otto engine, a diesel engine, or the like.

The device according to the invention provides a simple, economical, stable and safe transportation means. It enables transportation distances of up to 350 m or more and a transportation capacity of preferably 500 pers/h to 2,000 pers/h, and most preferably of about 720 to 1,440 pers/h. The driving power is preferably 1.5 kW to 20 kW and most preferably about 2.2 kW to 15 kW. The transportation speed is preferably in the range from 0.3 m/s to 4 m/s and most preferably in the range from about 0.8 m/s to 2 m/s, wherein the speed most preferably may be variably adjusted.

By the simple design, the transportation device according to the invention provides a lift which can be easily assembled and dismantled, which is economical and efficient as well as safe and economically-friendly and which also does not need any intermediate supports. Moreover, the transportation device is easily adjustable to different surroundings, the environment ad environmental conditions, such as snow conditions.

1. A device for the transportation of objects and/or persons, comprising:
at least one driving station and at least one deflection station as well as a transportation rope circulating between said stations;
a single driving wheel arranged at the driving station, and a single deflection pulley arranged at the return station; and
said driving wheel and said deflection pulley being arranged substantially vertically.

2. The device according to claim 1 wherein at least one of the deflection pulley and the driving wheel is suspended as a cantilever.

3. The device according to claim 2, wherein the cantilever suspension is adjustable.

4. The device according to claim 3, wherein at least one of the driving wheel and the deflection pulley has a diameter that is at least one of at least 60 times the diameter of the rope and at least 1 meter.

5. The device according to claim 4, wherein at least one of the driving wheel and the deflection pulley has a diameter that is at least 1.5 meters.

6. The device according to claim 5, wherein at least one of a transportation device and a holding device is arranged at the transportation rope.

7. The device according to claim 1, wherein at least one of the driving wheel and the deflection pulley has a diameter that is at least one of at least 60 times the diameter of the rope and at least 1 meter.

8. The device according to claim 7, wherein at least one of the driving wheel and the deflection pulley has a diameter that is at least 1.5 meters.

9. The device according to claim 8, wherein at least one of a transportation device and a holding device is arranged at the transportation rope.

10. The device according to claim 1, wherein at least one of a transportation device and a holding device is arranged at the transportation rope.

11. The device according to claim 2, wherein at least one of the driving wheel and the deflection pulley has a diameter that is at least one of at least 60 times the diameter of the rope and at least 1 meter.

12. The device according to claim 11, wherein at least one of the driving wheel and the deflection pulley has a diameter that is at least 1.5 meters.

13. The device according to claim 12, wherein at least one of a transportation device and a holding device is arranged at the transportation rope.

14. The device according to claim 2, wherein at least one of a transportation device and a holding device is arranged at the transportation rope.

15. The device according to claim 3, wherein at least one of a transportation device and a holding device is arranged at the transportation rope.
